(19) United States
(12) Patent Application Publication
(10) Pub. No.: US 2008/0093416 A1
(43) Pub. Date: Apr. 24, 2008

(54) Wire bonding and wire bonding method

(75) Inventors: Tetsuya Utano, Musashimurayama-shi (JP); Yutaka Kondo, Tachikawa-shi (JP); Toru Maeda, Tachikawa-shi (JP)

Correspondence Address: QUINN EMANUEL;KODA & ANDROLIA, 865 S. FIGUEROA STREET, 10TH FLOOR, LOS ANGELES, CA, 90017, US

(73) Assignee: Kabushiki Kaisha Shinkawa

(21) Appl. No.: 11/818,754

(22) Filed: Jun. 15, 2007

(30) Foreign Application Priority Data
Jun. 16, 2006 (JP) 2006-167074

(51) Int. Cl. B23K 1/06; B23K 1/00; B23K 3/00

(52) U.S. Cl. 228/1.1; 228/51; 228/44.3; 228/101; 228/110.1

(57) ABSTRACT

A tip end portion and an outer surface of a capillary (or of a wedge tool) used in, for instance, a wire bonding apparatus and method, being covered by a diamond layer with a heating element attached to the outer surface thereof. The inside of the capillary is formed by alumina ceramics, having a tapered hole. The tip end of the capillary is formed by the diamond layer, and a face portion and an inner chamfer portion are formed at the tip end to make a wire heating portion. Heat is transferred from the heating element to the wire heating portion through a heat supply path formed by the diamond layer, and a bonding surface formed by a wire and a pad is heated.

### BACKGROUND OF THE INVENTION

The present invention relates to a structure of a wire bonder for bonding a bonding wire to a semiconductor chip and to a lead frame and further relates to a wire bonding method.

A thermal pressure bonding method with ultrasonic wave is frequently used in wire bonding in which wire is bonded to a semiconductor chip. In the thermal pressure bonding method that uses ultrasonic wave, a bonding wire (merely called a “wire”) is pressure-bonded to a heated semiconductor chip by the ultrasonic wave, and the bonding property of a bonding portion is improved by heating. However, in the thermal pressure bonding method, not only the entirety of the semiconductor element including not only the pad of the semiconductor chip to which the wire is pressure-bonded but also a circuit region of a semiconductor element is heated, which sometimes causes breakage or degradation of the semiconductor chip.

Therefore, there is a proposed method in which the bonding portion is locally heated to lower the heating temperature of the entire semiconductor chip by heating only the bonding tool (for example, see Patent Document 1). As shown in FIG. 17, in this method, a heat storing portion 105 having a diameter larger than other portions is formed on a tip end side of a bonding tool 104, and a heating device 106 for heating the bonding tool 104 is attached to the side of an ultrasonic horn 103 of the heat storing portion 105. The bonding tool 104 is gripped by the ultrasonic horn 103, and an ultrasonic transmitting coil 102 is attached to one end of the ultrasonic horn 103. A semiconductor chip 107 to be bonded is vacuum-sucked to a heating stage 109 and heated. A lead 111 of a film carrier 108 is retained on a connected electrode 112 of the semiconductor chip 107 by a retaining mechanism 113.

In this wire bonding apparatus 101, first, the bonding tool 104 including the heat storing portion 105 is heated by the heating device 106. The heated bonding tool 104 is next pressed against the lead 111 to connect the lead 111 and the connected electrode 112 by heating and ultrasonic bonding. This makes the heating temperature to be lowered in the entirety of the semiconductor chip 107.

There is also a proposed method in which a ball pressure bonding surface at the tip end of a capillary is heated to bond a wire by a laser beam without heating the entirety of the semiconductor element (for example, see Patent Document 2). As shown in FIG. 18, in this method, a laser reflective film 124 is attached to the ruby outer surface of a capillary 121, and a laser absorption film 123 is attached to the ball pressure bonding surface at the tip end of a capillary 121. A laser beam 125, which is incident from above the capillary 121, advances toward the laser absorption film 123 at the tip end through the capillary 121 while being reflected by the laser reflective film 124 of the ruby outer surface of the capillary 121. The laser beam 125 that reaches the laser absorption film 123 at the tip end is absorbed and converted into heat by the laser absorption film 123; as a result, the ball pressure bonding surface is heated, and the ball pressure bonding surface heats the ball 127 formed at the tip end of wire 122. Then, the wire 122 is bonded by the heated ball 127 without heating the entirety of the semiconductor element.

There is a further proposed method in which a diamond thin-film layer having a thickness of 0.2 to 2.0 μm is formed on the ball pressure bonding surface at the tip end of a capillary of the wire bonding tool or of a wedge tool to improve the wear-resistant property of the bonding tool (for example, see Patent Document 3).

Patent Document 1: Japanese Patent Application Unexamined Publication Disclosure No. H5(1993)-109828

Patent Document 2: Japanese Patent Application Unexamined Publication Disclosure No. H6(1994)-104319

Patent Document 3: Japanese Patent Application Unexamined Publication Disclosure No. 2001-223237

However, in the conventional technique disclosed in Patent Document 1, there is a problem that the bonding surface is hardly kept at a necessary temperature for bonding during the bonding. From the viewpoints of hardness, wear-resistant property, and the like, bonding tools are generally made of alumina ceramics. Although the alumina ceramics have excellent hardness and wear-resistant property, the alumina ceramics have a thermal conductivity which is smaller than that of silicon that is used in semiconductor devices. On the other hand, contact electrodes are made of a metallic material whose thermal conductivity is larger than that of alumina ceramics. Therefore, in the case where the tip end of a heated bonding tool comes into contact with the metallic material, the heat at the tip end of the high-temperature bonding tool flows into the metallic material to raise the temperature of the bonding portion. At the same time, the heat flow from the heat storing portion 105 to the tip end portion of the bonding tool is smaller than the flow rate of the heat diffused from the bonding surface toward the semiconductor chip 107, so that the initial temperature cannot be kept in the bonding surface and the temperature is rapidly lowered. Accordingly, in the conventional technique disclosed in Patent Document 1, the problem is that it is difficult to heat the bonding surface in an efficient manner.

In the conventional technique disclosed in Patent Document 2, the inside of the capillary forms an optical waveguide for the heating laser beam. Therefore, although this conventional technique can be applied to a material such as a ruby having translucency, the problem is that this conventional technique cannot be applied to a non-translucent material such as alumina ceramics, which are frequently used for bonding tools.

### BRIEF SUMMARY OF THE INVENTION

An object of the present invention is to provide a wire bonder that heats the bonding surface of a wire pressure-bonded to pad and lead on a semiconductor chip to a high temperature by heating a bonding tool from the outer surface thereof.

According to the present invention, the present invention provides a wire bonder provided with a wire bonding tool for bonding a wire to bonding objects (a pad on a semiconductor chip and a lead on a lead frame), the wire bonder comprising:
a wire heating portion for heating the wire, the wire heating portion being formed at a tip end portion of the wire bonding tool;
a heat source for generating heat to heat the wire, the heat source being formed on the outer surface side of the wire bonding tool; and
a heat supply path for supplying heat for heating the wire from the heat source to the wire heating portion.

In other words, the wire bonder of the present invention includes a wire bonding tool, and this wire bonding tool is provided with: a heat source provided on the outer surface so as to generate heat for heating the wire; a wire heating portion provided at the tip end area to contact and heat the wire; and a heat supply path provided to allow the heat for heating the wire to travel from the heat source to the wire heating portion.

In the wire bonder according to the present invention, preferably,
the wire bonder further comprises a computer for controlling pressure-bonding of the wire to the bonding objects, and
this computer includes a temperature keeping means for keeping the temperature of the bonding surface formed by the wire and the bonding objects at a wire bonding temperature that is higher than the temperature of a circuit component portion of the semiconductor chip when the wire is pressure-bonded to the bonding objects by the wire bonding tool.

In the wire bonder according to the present invention, preferably,
the wire bonder further includes a moving mechanism for moving the wire bonding tool in XYZ directions to bond the wire to the bonding objects, and
the computer further includes a vibration means for vibrating the tip end portion of the wire bonding tool relative to the semiconductor chip using the moving mechanism when the wire is pressure-bonded to the boning objects by the wire bonding tool.

In the wire bonder according to the present invention, preferably the heat supply path is made of a material having a thermal conductivity larger than that of the semiconductor chip.

In the wire bonder according to the present invention, preferably the heat supply path is made of a diamond crystal or a nano-carbon material.

In the wire bonder according to the present invention, preferably the computer further includes a heat source temperature adjusting means for keeping the heat source at a predetermined temperature when the wire is not pressure-bonded to the bonding objects by the wire bonding tool.

In the wire bonder according to the present invention, preferably the computer further includes a heat generation stop means for stopping heat generation in the heat source when the wire bonding tool is being moved from one semiconductor chip to a next semiconductor chip.

In the wire bonder according to the present invention, preferably the temperature keeping means keeps the temperature of the bonding surface formed by the wire and the bonding objects at a wire bonding temperature that is higher than the temperature of a circuit component portion of the semiconductor chip based on the electrical resistance value of the heat source.

According to the present invention, the present invention provides a wire bonding method for a wire bonder, comprising the steps of:
providing the wire bonder including
   a wire bonding tool for bonding a wire to bonding objects (a pad on a semiconductor chip and a lead on a lead frame),
   a wire heating portion for heating the wire, the wire heating portion being formed at the tip end portion of the wire bonding tool,
   a heat source for generating heat to heat the wire, the heat source being formed on the outer surface side of the wire bonding tool,
   a heat supply path for supplying heat for heating the wire from the heat source to the wire heating portion, and
   a computer for controlling pressure-bonding of the wire to the bonding objects; and
keeping the temperature of the bonding surface formed by the wire and the bonding objects at a wire bonding temperature higher than the temperature of a circuit component portion of the semiconductor chip when the wire is pressure-bonded to the bonding objects by the wire bonding tool.

Preferably the wire bonding method of the wire bonder according to the present invention further includes the steps of:
providing a moving mechanism for moving the wire bonding tool in XYZ directions to bond the wire to the bonding objects; and
vibrating the tip end portion of the wire bonding tool relative to the semiconductor chip using the moving mechanism when the wire is pressure-bonded to the bonding objects by the wire bonding tool.

The wire bonding method according to the present invention, preferably, further includes a step of adjusting the heat source temperature to keep the heat source temperature at a predetermined temperature when the wire is not pressure-bonded to the bonding objects by the wire bonding tool.

The wire bonding method according to the present invention, preferably, further includes a step of stopping heat generation in the heat source when the wire bonding tool is being moved from one semiconductor chip to a next semiconductor chip.

In the wire bonding method according to the present invention, preferably, the temperature keeping step keeps the temperature of the bonding surface formed by the wire and the bonding objects at a wire bonding temperature that is higher than the temperature of a circuit component portion of the semiconductor chip based on the electrical resistance value of the heat source.

The present invention provides an advantageous effect that=the bonding surface of a wire to be pressure-bonded to the bonding objects can be heated to a high temperature by heating the bonding tool from the outer surface thereof.

### BRIEF DESCRIPTION OF THE SEVERAL VIEWS OF THE DRAWINGS

FIG. 1 is a system diagram showing the structure of an embodiment of a wire bonder according to the present invention;

FIG. 2(a) is a perspective view showing an attachment state of a capillary in the embodiment of the wire bonder according to the present invention, FIG. 2(b) being a top plan view of the capillary;

FIG. 3 is a sectional view showing the capillary and the capillary attaching mechanism of FIG. 2;

FIG. 4 is a sectional view showing the tip end of the capillary in the embodiment of the wire bonder according to the present invention;

FIG. 5 is an explanatory view showing the heat flow before bonding in the embodiment of the wire bonder according to the present invention;

FIG. 6 is an explanatory view showing the heat flow during bonding in the embodiment of the wire bonder according to the present invention;

FIG. 7 is a graph showing the temperature changes in the heat source and the bonding surface in the embodiment of the wire bonder according to the present invention;

FIG. 8 is a graph showing the analytical result of changes in bonding surface temperature after bonding in the embodiment of the wire bonder according to the present invention, FIG. 8 including an illustration showing the heat flow during bonding in the embodiment of the wire bonder according to the present invention;

FIGS. 9 (a) and 9(b) are sectional views of the capillaries according to the present invention;

FIG. 10 is a perspective view showing the capillary attaching mechanism in another embodiment of a wire bonder according to the present invention;

FIG. 11(a) is a view showing the outline of the wedge tool in an embodiment of a wire bonder according to the present invention, FIG. 11(b) being an enlarged cross-sectional view of the tip end thereof;

FIG. 12 is a flowchart of an embodiment of a wire bonding method and a boding program according to the present invention;

FIG. 13 is an operation timing chart of the embodiment of the wire bonding method and program according to the present invention;

FIG. 14 is a graph showing the relationship between the temperature and the electrical resistance of a heat source;

FIG. 15 is a flowchart of another embodiment of the wire bonding method and program according to the present invention;

FIG. 16 is an operation timing chart of another embodiment of the wire bonding method and program according to the present invention;

FIG. 17 is an explanatory view of a bonding apparatus having a conventional capillary heating device; and

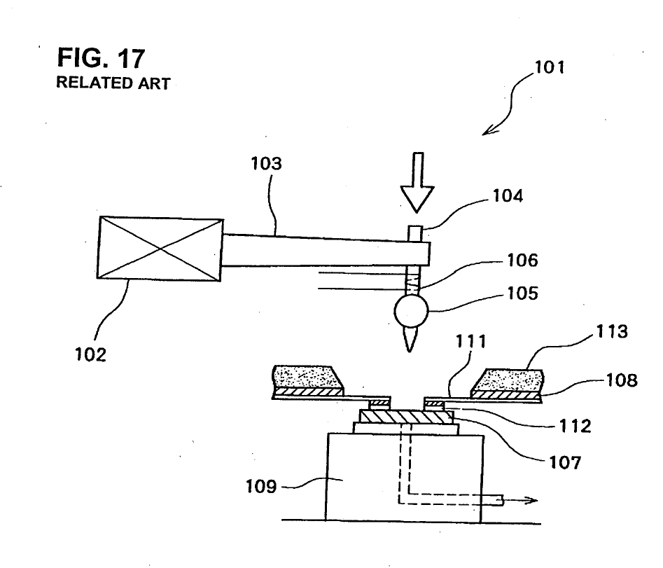

FIG. 18 is an explanatory view of a conventional capillary heating method.

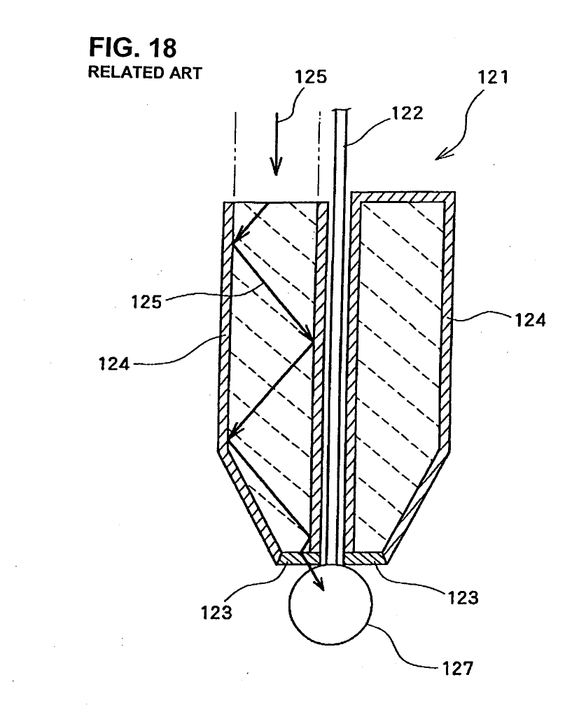

### DETAILED DESCRIPTION OF THE INVENTION

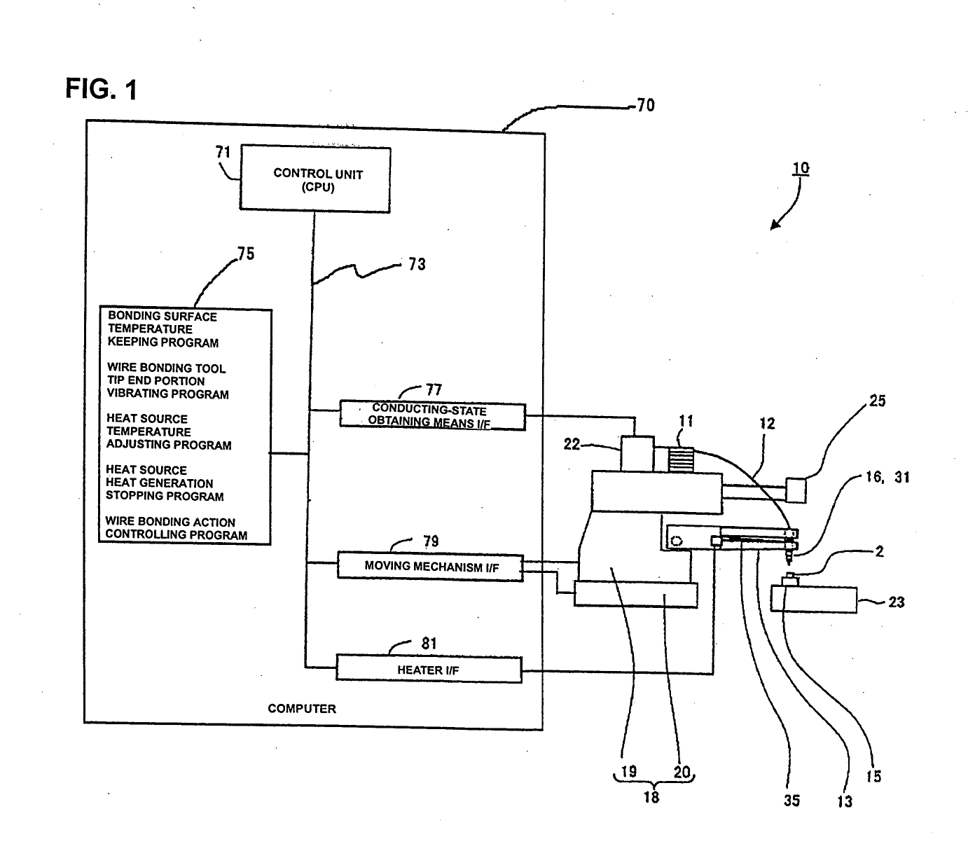

Hereinafter preferred embodiments of the present invention will be described below with reference to the accompanying drawings. FIG. 1 is a system diagram showing the system structure of an embodiment of the wire bonder according to the present invention.

As shown in FIG. 1, in a wire bonder 10, a bonding head 19 is mounted on an XY table 20. The bonding head 19 is provided with a bonding arm 13 whose tip end is driven by a motor in a Z direction which is a vertical direction. A capillary 16 which is a bonding tool is attached to the tip end of the bonding arm 13. The XY table 20 and the bonding head 19 form a moving mechanism 18. The moving mechanism 18 can move the bonding head 19 to any positions in a horizontal plane (in XY plane) using the XY table 20, and the capillary 16 attached to the tip end of the bonding arm 13 can freely be moved in the XYZ directions by driving the bonding arm 13 attached to the moving mechanism 18.

A wire 12 is wound on a spool 11 and is inserted into the capillary 16. The wire 12 on the spool 11 is connected to conducting-state obtaining means 22 for obtaining an electrical conducting state between the wire 12 and a pad on a semiconductor chip 2 or between the wire 12 and a lead 4 on a lead frame 15.

A position sensing camera 25 which confirms a position of the semiconductor chip 2 is attached to the bonding head 19. A suction stage 23 is provided below the capillary 16, so that the suction stage 23 sucks and fixes the lead frame 15 on which the semiconductor chip 2 is mounted.

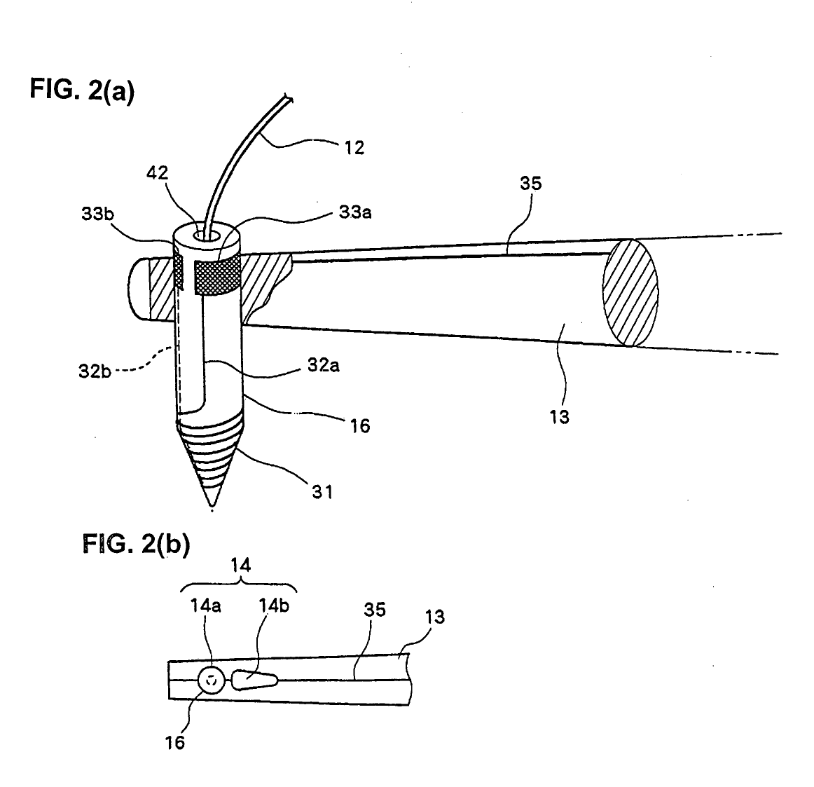

A heater 31 is attached to the outer surface of the capillary 16 (see FIG. 2(a)). The heater 31 is a heat source which generates heat for heating the wire 12 when the pressure bonding of the wire 12 is performed to the semiconductor chip 2. An electric wiring 35 through which electric power is supplied to the heater 31 is attached to the bonding arm 13.

The moving mechanism 18 is connected to a moving mechanism interface 79, the conducting-state obtaining means 22 is connected to a conducting-state obtaining means interface 77, and the heater 31 is connected to a heater interface 81. The interfaces are connected through a data bus 73 to a control section 30 that controls the bonding action, which are respectively the component parts of a computer 70. The control section 71 is provided therein with a CPU (central processing unit) used for controlling the bonding action. To the data bus 73 is connected a memory unit 75 which stores control data and programs including a program for keeping the temperature of the bonding surface, a program for vibrating the tip end portion of the wire bonding tool, a program for adjusting the heat source temperature, a program for stopping heat generation in the heat source, and a control program.

FIG. 2(a) is a partially sectional perspective view showing the capillary 16 and a tip end of the bonding arm 13 to which the capillary 16 is attached. The bonding arm 13 tapers toward the tip end, and the bonding arm 13 includes a gripping portion 14 (see FIG. 2(b)) at a position near the tip end. The gripping portion 14 is a mechanism for attaching the capillary 16 to the bonding arm 13.

As shown in FIG. 2(b), the gripping portion 14 is formed by combining a gripping hole 14a and a slit 14b. The gripping hole 14a has an inner diameter smaller than the outer diameter of the capillary 16, and the slit 14b is located in the axial direction of the capillary 16. The slit 14b is opened and closed by a specialized tool, which allows the diameter of the gripping hole 14a to be increased larger than the outer diameter of the capillary 16 or decreased smaller than the outer diameter of the capillary 16. When the capillary 16 is attached to the bonding arm 13, after the diameter of the gripping hole 14a of the gripping portion 14 is increased by the specialized tool, the capillary 16 is inserted into the hole, and then the specialized tool is removed so that the capillary 16 is clamped from both sides by the elastic force of the bonding arm 13. The mechanism for attaching the capillary 16 is not limited to the above structure, and the capillary 16 can be attached in a simple hole with a fastening tool such as a screw as long as the capillary 16 can be gripped by the bonding arm 13.

As shown in FIG. 2(a), the base portion of the capillary 16 has a cylindrical shape, and the tip end portion has a conical shape. The heater 31 is wound around the outer surface of the capillary 16 from the cylindrical portion toward the tip end portion. The heater 31 is formed by evaporating platinum onto the surface of the capillary 16. Alternatively, the heater can be formed by winding an electric resistance wire around the capillary. Both ends of the heater 31 are connected to contact electrodes 33a and 33b through conducting paths 32a and 32b, respectively. The conducting paths 32a and 32b are formed by evaporation coating on the surface of the capillary 16, and the contact electrodes 33a and 33b are formed by evaporation coating on the cylindrical outer surface of the base portion of the capillary 16.

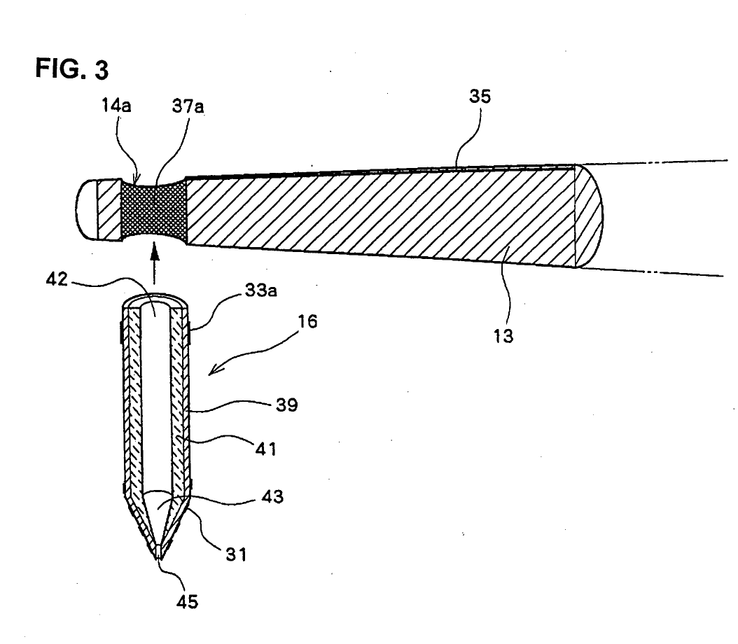

FIG. 3 is a view showing the bonding arm 13 and a section of the capillary 16. As shown in FIG. 3, a bonding arm contact electrode 37a is attached to the inner surface of the gripping hole 14a of the gripping portion 14, and the bonding arm contact electrode 37a is connected to the contact electrode 33a formed on the outer surface of the capillary 16. A bonding arm contact electrode 37b (not shown) is attached to the inner surface (not shown) on the opposite side of the gripping hole 14a of the gripping portion 14, and the bonding arm contact electrode 37b on the bonding arm 13 is connected to the contact electrode 33b of the capillary 16. The contact electrodes 33a and 33b are electrically insulated from each other, and the bonding arm contact electrodes 37a and 37b are electrically insulated from each other. The bonding arm contact electrodes 37a and 37b are connected to the heater electric wiring 35, respectively. Electric power is supplied to the heater 31 from a power supply (not shown) through the heater electric wiring 35, the bonding arm contact electrodes 37a and 37b, the contact electrodes 33a and 33b, and the conducting paths 32a and 32b.

The electric power is supplied to the heater 31 along the bonding arm 13 as described above; however, an electric power supply line can separately be provided and directly connected to the heater 31 of the capillary 16.

As shown in FIG. 3, the capillary 16 is comprised of a ceramics portion 41 made of alumina ceramics in the center thereof, and a diamond layer 39 which is formed on the outer surface of the capillary 16. The diamond layer 39 can be formed in the form of a diamond crystal by physically evaporating a carbon ion, or the diamond layer 39 can be formed by growing a diamond layer around the ceramics portion 41. Either a polycrystalline diamond layer or a single-crystal diamond layer can be used as the diamond layer 39. The heater 31 and the contact electrode 33a and 33b are formed on the outer surface of the diamond layer 39 by evaporation coating. The diamond layer has a thickness ranging from 20 to 30 μm.

A wire insertion hole 42 is made in the center of the capillary 16, and a straight hole 45 having an inner diameter slightly larger than the outer diameter of the wire is made in the tip end of the capillary 16. The wire insertion hole 42 and the straight hole 45 are connected by a tapered hole 43. Since the diamond layer 39 having high hardness is formed on the outer surface of the capillary 16, the internal central portion of the capillary 16 can be made of a metallic material such as titanium whose hardness is lower than that of alumina ceramics.

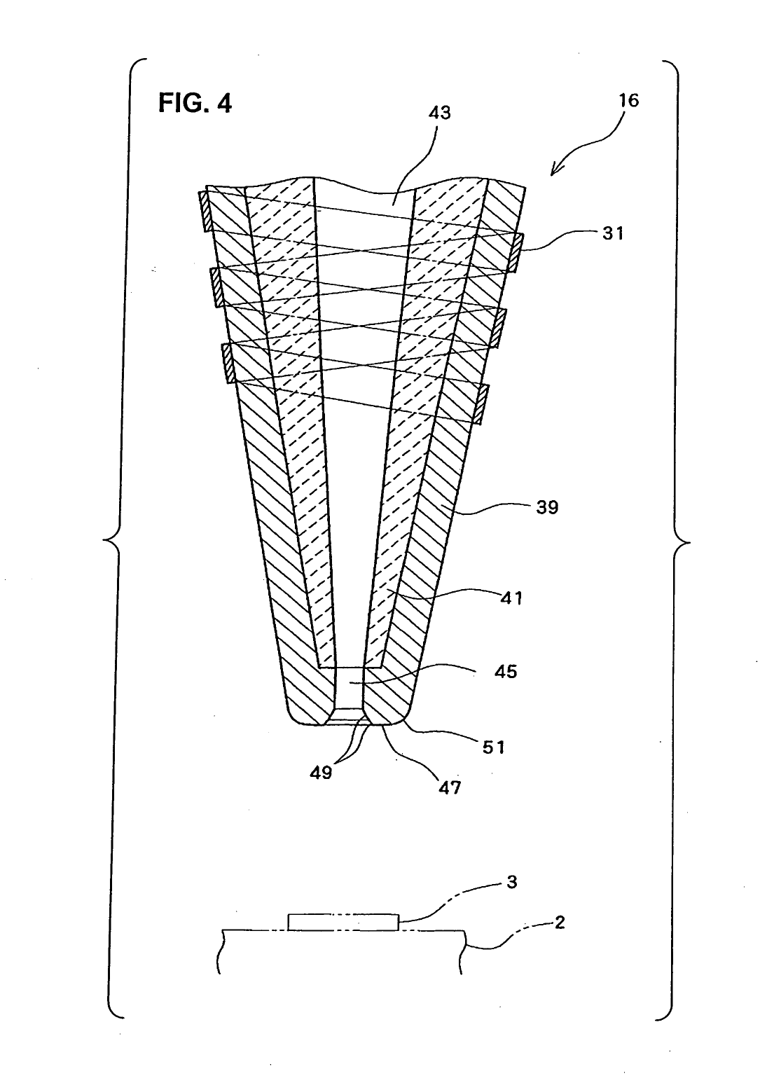

FIG. 4 is an enlarged sectional view showing the tip end portion of the capillary 16. As shown in FIG. 4, the tip end portion and outer surface of the capillary 16 are covered with the diamond layer 39, and the heater 31 is attached to the outer surface of the capillary 16. The inside of the tip end portion is formed by the ceramics portion 41 having the tapered hole 43.

A face portion 47 is provided in the surface of the diamond layer 39 at the tip end. When bonding is executed, the face portion 47 performs pressure bonding of a ball 5, formed at the tip end of the wire 12, to a pad 3 of the semiconductor chip 2. The straight hole 45 and an inner chamfer portion 49 are provided while penetrating through the diamond layer 39. The face portion 47 and the inner chamfer portion 49 structure a wire heating portion.

As shown in FIG. 4, the face portion 47 is provided in the tip end surface of the capillary 16, and a micro angle is formed between the face portion 47 and the pad 3 when the face portion 47 contacts the pad 3. The tapered portion and face portion 47 at the tip end are smoothly connected by an outer radius portion 51 in a corner portion. The inner chamfer portion 49 is a two-stage tapered hole made between the straight hole 45 and the face portion 47, and the inner chamfer portion 49 is spread toward the face portion 47.

The inner chamfer portion 49 has angles with respect to an operation direction (vertical direction) and a radial direction (horizontal direction) of the capillary 16. Accordingly, the inner chamfer portion 49 compresses the ball 5 in the radial direction to form a pressure bonding ball while pressing the ball 5 against the pad 3 in the bonding. The inner chamfer portion 49 is not limited to the two-stage tapered hole, but a one-stage tapered hole or a hole whose inner surface is formed by a curved surface can be used as the inner chamfer portion 49 as long as the inner chamfer portion 49 performs the pressure bonding of the ball 5 to form the pressure bonding ball.

The face portion 47 is not limited to a plane that forms the micro angle with respect to the pad 3 as in the shown embodiment. For example, as long as the face portion 47 has the shape in which the ball 5 is pressure-bonded to the pad 3, the face portion 47 can be formed by a curved surface or a surface which is parallel to the pad 3 with no angle.

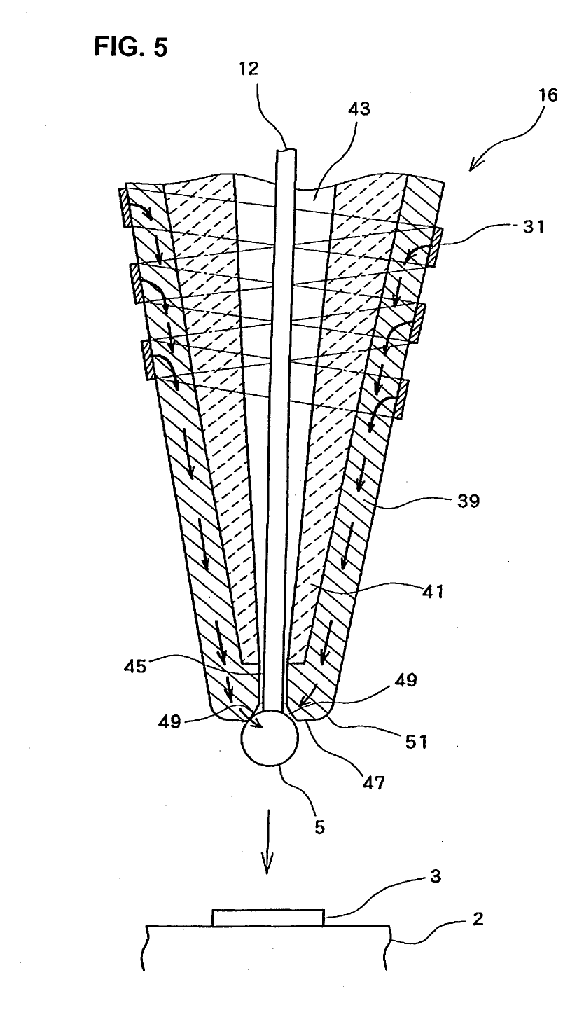

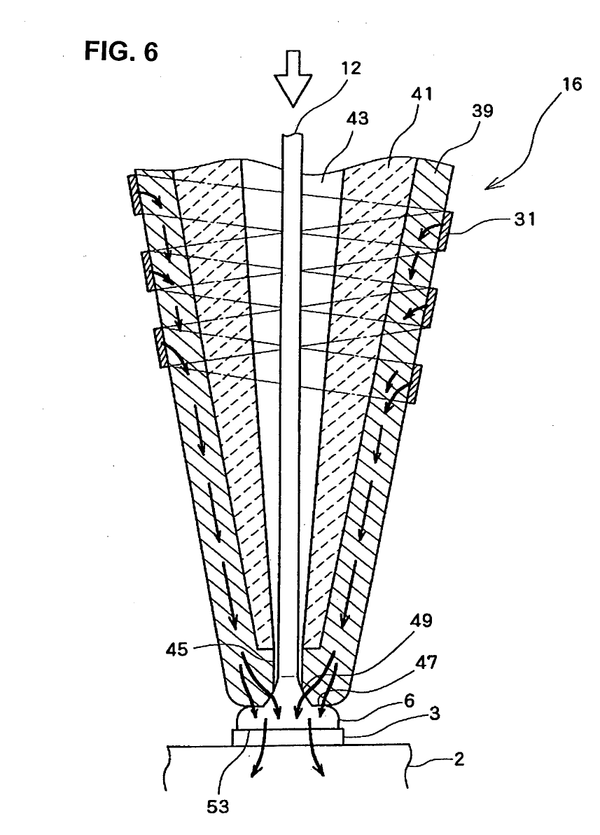

Transfer of the heat generated by the heater 31 of the present invention and heat inflow to the pressure bonding surface during the pressure bonding will be described below with reference to FIGS. 5 and 6. FIG. 5 shows a heat flow at the tip end of the capillary 16 before bonding, and FIG. 6 shows a heat flow at the tip end of the capillary 16 during bonding.

As shown in FIG. 5, before bonding, the bonding ball 5 is formed at the tip end of the wire 12 inserted in the capillary 16. The ball 5 has a diameter larger than the diameter of the face portion 47 of the inner chamfer portion 49. The electric current is applied to the heater 31 before bonding, and the diamond layer 39 on the outer surface of the capillary 16 is heated by the heat of the heater 31. The diamond has an extremely high thermal conductivity, and the thermal conductivity ranges from 1000 to at least 2000 W/mK at room temperature. The heat entering the diamond layer travels to the inner chamfer portion 49, straight hole 45, and face portion 47 at the tip end through the diamond layer 39 by thermal conduction. The entire diamond layer 39 at the tip end of the capillary 16 is heated by the transferred heat.

On the other hand, the wire 12 made of gold is inside the straight hole 45 and inner chamfer portion 49, and the ball 5 is formed at the tip end of the wire 12. The wire 12 and the ball 5 are, as a result, heated by the heat flowing from contact points at which the wire 12 is in contact with the straight hole 45 and the inner chamfer portion 49. The ceramics portion 41 located inside has the thermal conductivity ranging from 20 to 40 W/mK at room temperature, and the ceramics portion 41 is extremely smaller than the diamond layer 39 in the thermal conductivity, as a result, the ceramics portion 41 is not too heated by the heat of the diamond layer 39 located on the outer surface of the capillary 16.

As shown in FIG. 6, when the ball 5 is pressed against the pad 3, which is a bonding object in the present invention, to perform the pressure bonding by moving the capillary 16 downward, the surfaces of the face portion 47 and inner chamfer portion 49 are pressure-contacted to the ball 5 to deform the ball 5, which forms the pressure bonding ball 6. The pressure bonding ball 6 is pressure-bonded to the pad 3 by a disk shaped bonding (or contact) surface 53 which is formed by (or lies between) the wire 12 (or the ball 6) and the pad 3. Thus, the downward force of the capillary 16 is transmitted to the upper surface of the pressure bonding ball 6 through the inner chamfer portion 49 and face portion 47 which are located at the tip end of the capillary 16, and the downward force acts as a pressure bonding force of the bonding surface 53 formed by the pressure bonding ball 6 and the pad 3.

As shown by arrows in FIG. 6, as in the flow of the pressure bonding force, the heat of the heater 31 is transferred to the upper surface of the pressure bonding ball 6 through the inner chamfer portion 49 and face portion 47 which are located at the tip end of the capillary 16, and the heat flows to the bonding surface 53 formed by (or formed between) the pressure bonding ball 6 and the pad 3 to heat the bonding surface 53. Since the surfaces to which the force flows are pressure-bonded to each other, the thermal resistance is decreased at the surfaces to facilitate the heat flow. Accordingly, the heat transferred to the pressure bonding ball 6 from the heater 31 is largely increased compared with the pre-bonding.

As described above, the heat from the heater 31 flows to the pressure bonding ball 6 through the pressure bonding surfaces of the inner chamfer portion 49 and face portion 47, i.e., through the wire pressure bonding surface of the wire heating portion. Accordingly, it is necessary that the heat supply path, formed by the diamond layer 39, between the heater 31 and the wire pressure bonding surface have a sufficiently large cross section in order to transfer the heat. When the cross section is small, a heat quantity transferred from the wire pressure bonding surface to the pressure bonding ball 6 is smaller than a heat quantity supplied from the heater 31 to the wire pressure bonding surface, and the heat quantity cannot sufficiently be supplied to the bonding surface 53. However, since actually heat loss is generated by radiation from the surface of the diamond layer 39, a certain level of thickness is required in addition to the above necessary cross section. For practical purpose, when the thickness is not lower than 20 μm, the heat of the heater 31 can be supplied to the tip end of the capillary 16 even if the radiation loss is generated. In the shown embodiment, the diamond layer 39 has the thickness ranging from 20 to 30 μm.

On the other hand, the heat transferred from the heater 31 flows from the bonding surface 53 toward the semiconductor chip 2 through the pad 3 by the thermal conduction, and the heat is diffused into the semiconductor chip 2 from the pad 3.

When it is assumed that the thermal resistances of the bonding surface 53 and the pressure bonding surfaces of the inner chamfer portion 49 and face portion 47 can be omitted because the thermal resistances becomes extremely small by the pressure bonding compared with the thermal resistance of the diamond layer 39, and when it is also assumed that the heat transfer area is substantially the same from the heater 31 to the pad 3 because the area of the bonding surface 53 is substantially equal to the area of the upper surface of the pad 3, namely, the pressure bonding ball 6 and the pad 3 are bonded for the entire upper surface of the pad 3, then in order to make the heat quantity supplied from the heater 31 to the bonding surface 53 larger than the heat quantity flowing toward the thickness direction of the pad 3 from the bonding surface 53, it is necessary that the thermal conductivity of the material forming the heat supply path be larger than the thermal conductivity of at least the pad 3. In the shown embodiment, the heat supply path is formed by the diamond layer 39, the thermal conductivity of the heat supply path ranges from 1000 to at least 2000 W/mK at room temperature, the pad 3 and the semiconductor chip 2 are made of silicon, and the thermal conductivity of the pad 3 ranges from 100 to 200 W/mK at room temperature. Accordingly, in the shown embodiment, the heat supply path is formed by the diamond layer 39 having the thermal conductivity larger than that of silicon.

The material of the heat supply path is not limited to diamond as long as the material of the heat supply path has a thermal conductivity larger than that of the semiconductor chip 2 to which the wire is pressure-bonded. For example, the heat supply path can be preferably made of a nano-carbon material having the thermal conductivity similar to that of diamond. The material of the heat supply path is not limited to carbon system materials, but any material except for the carbon system materials can be used in the heat supply path as long as the material has a thermal conductivity larger than that of the semiconductor chip 2 to which the wire is pressure-bonded.

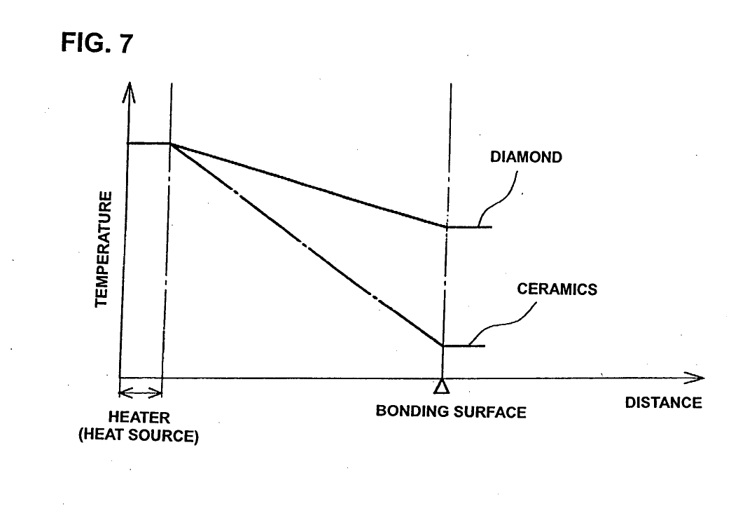

FIG. 7 shows a temperature drop relative to a distance between the heater 31 and the bonding surface 53. In FIG. 7, the solid line indicates the temperature drop of the embodiment in which the heat supply path is formed by the diamond layer 39, and the alternate long and short dash line indicates the temperature drop in the case where the entire capillary 16 is made of alumina ceramics, namely, in the case where the heat supply path is also made of alumina ceramics.

As seen from FIG. 7, in the case where the heat supply path is formed by the diamond layer 39, the temperature drop from the heater 31 to the bonding surface 53 is significantly small compared with the alumina ceramics, and the bonding surface 53 can be heated to a high temperature by the heat supplied from the heater 31.

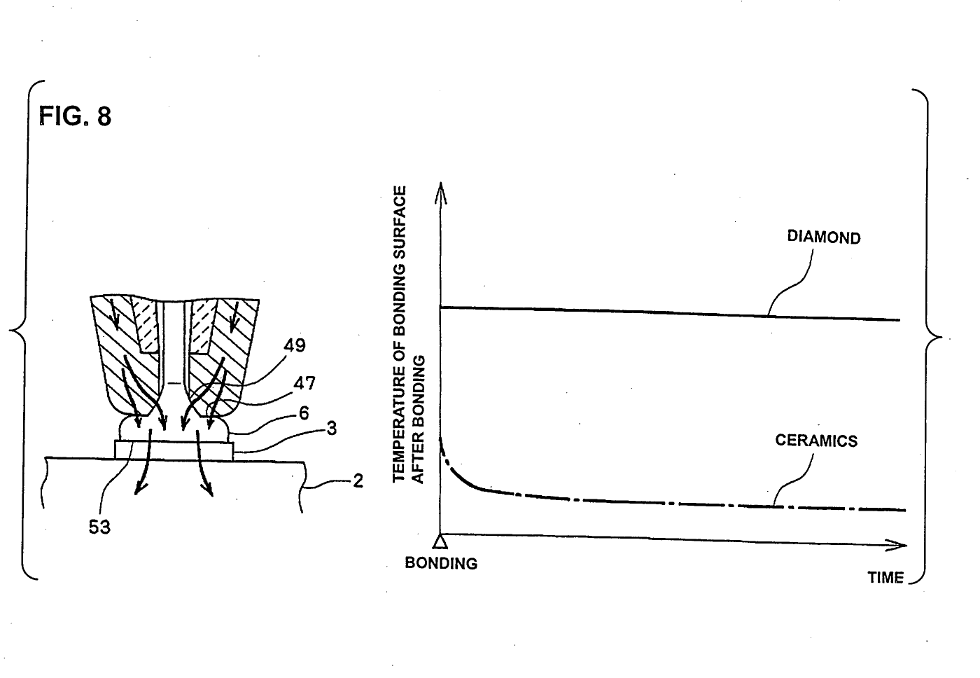

FIG. 8 shows analytical result of computation for the temperature drop of the bonding surface 53 after bonding. In FIG. 8, the solid line indicates the analytical result in the case where the heat supply path is formed by the diamond layer, and the alternate long and short dash line indicates the analytical result in the case where the heat supply path is made of ceramics. In an initial condition of the analysis for both cases, the heater is set to a temperature of about 500° C. FIG. 8 shows the temperature change in the bonding surface 53 when the heater 31 is kept at a constant temperature.

As is clear from FIG. 8, in the case where the heat supply path is formed by the diamond layer 39, the heat quantity supplied from the heater 31 to the region that includes from the bonding ball 6 to the bonding surface 53 through the pressure bonding surfaces of the inner chamfer portion 49 and face portion 47, i.e., through the wire pressure bonding surface of the wire heating portion is equal to the heat quantity diffused into the semiconductor chip 2 from the bonding surface 53 through the pad 3. Therefore, the bonding surface 53 can be kept at a necessary temperature for the bonding. On the other hand, in the case of the ceramics, the heat quantity supplied to the bonding surface 53 is smaller than the heat quantity diffused from the bonding surface 53 into the semiconductor chip 2 through the pad 3. Therefore, once the wire 12 is pressure-bonded to the pad 3, the temperature of the bonding surface 53 rapidly decreases from the necessary temperature for bonding to the temperature equal to the temperature of the circuit component portion of the semiconductor chip.

As described above, since the heat supply path is formed by the diamond layer 39 on the outer surface of the capillary 16, the shown embodiment has an advantageous effect that the temperature of the bonding (or contact) surface 53 which is formed by (or lies between) the wire 12 (or the ball 6) and the pad 3 can be heated to high temperature during the bonding compared with the case in which the heat supply path is made of ceramics. Therefore, even if the heating amount is decreased in the entire semiconductor chip 2, the embodiment has the advantageous effect of being able to keep the bonding surface 53 at a wire bonding temperature higher than the temperature of the entire semiconductor chip 2 to prevent the damage of the semiconductor chip 2 caused by the heating. The wire bonding temperature is a temperature at which the bonding property of the bonding portion can be improved, e.g., a temperature ranging from 200° C. to 300° C. Furthermore, since the heater 31 is heated to a higher temperature, the shown embodiment also has the advantageous effect of being able to perform the wire bonding in which the bonding surface 53 can be kept at the wire bonding temperature without heating the entire semiconductor chip 2.

In the above-described embodiment, the heat supply path is formed by allowing the diamond layer 39 to grow on the outer surface of the ceramics portion 41 or by allowing the carbon ion to evaporate on the outer surface of the ceramics portion 41. Therefore, the embodiment has an advantageous effect that it is not necessary that expensive, hard-forming material be used in the bonding tool although the material has translucency. Since the diamond layer 39 having the high hardness is formed on the surface of the capillary 16, the embodiment has an advantageous effect that the inside of the capillary can be made of the metallic material having the hardness lower than that of alumina ceramics.

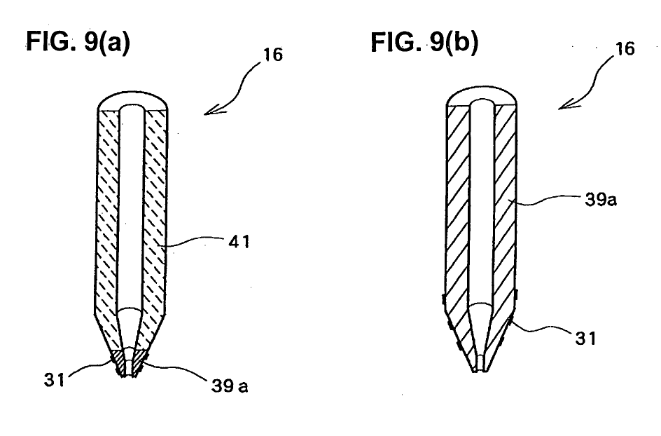

Another embodiment of the present invention will be described with reference to FIGS. 9(a) and 9(b). The same component as the above-described embodiment is designated by the same numeral, and the description thereof is omitted.

FIG. 9(a) shows the capillary in which the entire tip end portion is formed by a diamond block 39a bonded and fixed to the ceramics portion 41 with a bonding agent such as silver solder. The heater 31 is formed on the surface of the diamond block 39a by evaporation coating. In this embodiment, although the diamond block has a length ranging about 0.6 to about 1.0 mm, the diamond block can be formed longer when the heater 31 can be formed by evaporation coating and bonded to the ceramics portion 41.

FIG. 9(b) shows the case in which the entire capillary 16 is formed by a diamond block 39a, and the heater 31 is formed on the outer surface of the diamond block 39a by evaporation coating in the same manner as in the above-described embodiment.

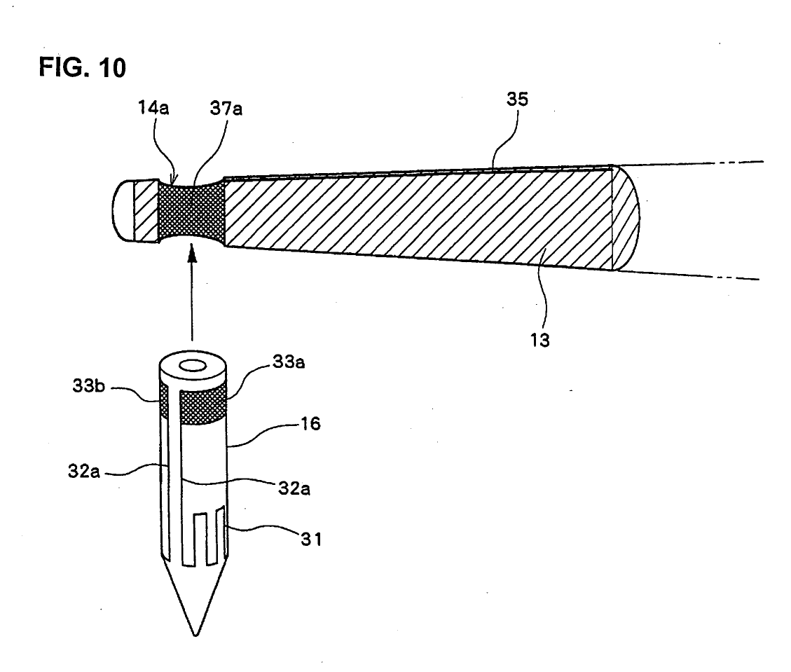

FIG. 10 shows a serpentine-shape heater 31 which is formed on the outer surface of the capillary 16 by evaporation coating. In the serpentine-shape heater 31, the heater is folded up and down along the outer peripheral surface of the capillary 16. The manner of attaching the capillary 16 to the bonding arm 13 and the electric power supply to the heater is the same as that of the above-described embodiment.

With respect to the advantageous effects of the embodiments shown in FIGS. 9(a) through 10, as in the advantageous effects of the above-described embodiment, since the heat supply path is formed by the diamond block 39a, the bonding surface can be heated to high temperature during the bonding compared with the case in which the heat supply path is made of ceramics. Additionally, the temperature of the entirety of the semiconductor chip 2 can be decreased, or the bonding can be performed in an efficient manner without heating the entirety of the semiconductor chip 2.

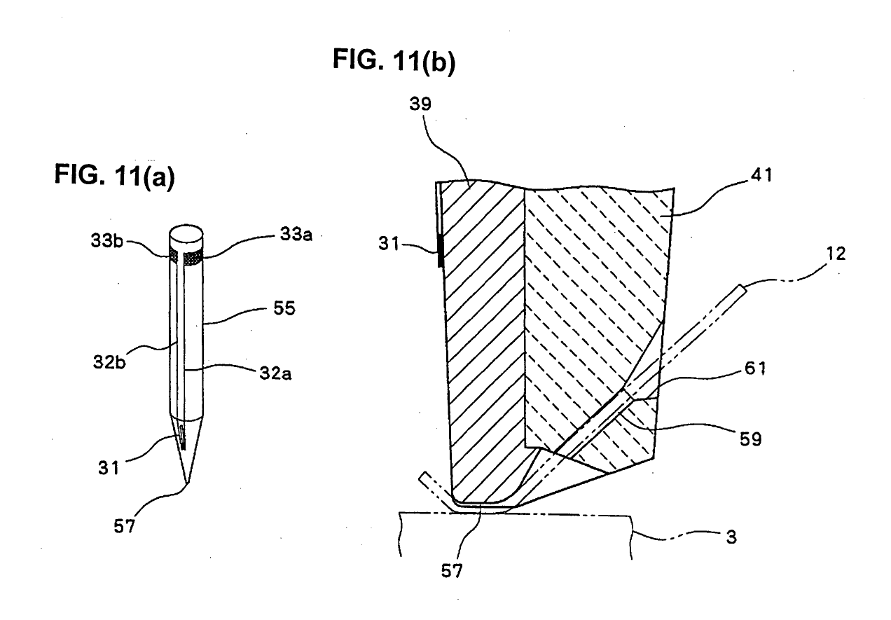

FIGS. 11(a) and 11(b) show an embodiment in which the present invention is applied to a wedge tool which is another type of wire bonding tool. FIG. 11(a) is a perspective view showing the entire wedge tool, and FIG. 11(b) is a sectional view showing the tip end of the wedge tool.

As shown in FIG. 11(a), as in the capillary 16, the wedge tool 55 has a cylindrical base portion and a conical tip-end portion. A serpentine-shape heater 31 made of platinum by evaporation coating is formed on the outer surface from the cylindrical portion toward the tip end portion of the wedge tool 55. Alternatively, the heater 31 can be formed by an electric resistance wire. Both ends of the heater 31 are connected to the contact electrodes 33a and 33b through the conducting paths 32a and 32b, respectively. The conducting paths 32a and 32b are formed by evaporation coating on the surface of the wedge tool 55, and the contact electrodes 33a and 33b are formed by evaporation coating on the cylindrical outer surface of the base portion of the wedge tool 55.

A tapered guide hole 61 and a wire feed hole 59, into which a wire 12 is inserted, are obliquely made in one surface at the tip end of the wedge tool 55. A bonding foot 57 where the inserted wire 12 is pressure-bonded to the pad 3 is formed in front of the wire feed hole 59. The bonding foot 57 forms a wire heating portion, and the bonding foot 57 also forms a wire pressure bonding surface. The heat supply path from the heater 31 to the bonding foot 57 is formed by a diamond layer 39 on the side on which the bonding foot 57 is formed. On the other hand, the side where the wire feed hole 59 and tapered guide hole 61 are provided is formed by a ceramics portion 41. As in the capillary 16 describe above, in the embodiment of FIGS. 11(a) and 11(b), the diamond layer 39 has a thickness ranging from 20 to 30 μm.

A wire bonder to which the wedge tool 55 having the above structure is attached has an advantageous effect of being able to correspond to a finer pitch in addition to the advantageous effects of the capillary 16 described above.

As in the capillary 16, in the wedge tool 55, preferably the diamond block 39a is used in the tip end portion, and the entire wedge tool 55 is formed by the diamond block 39a.

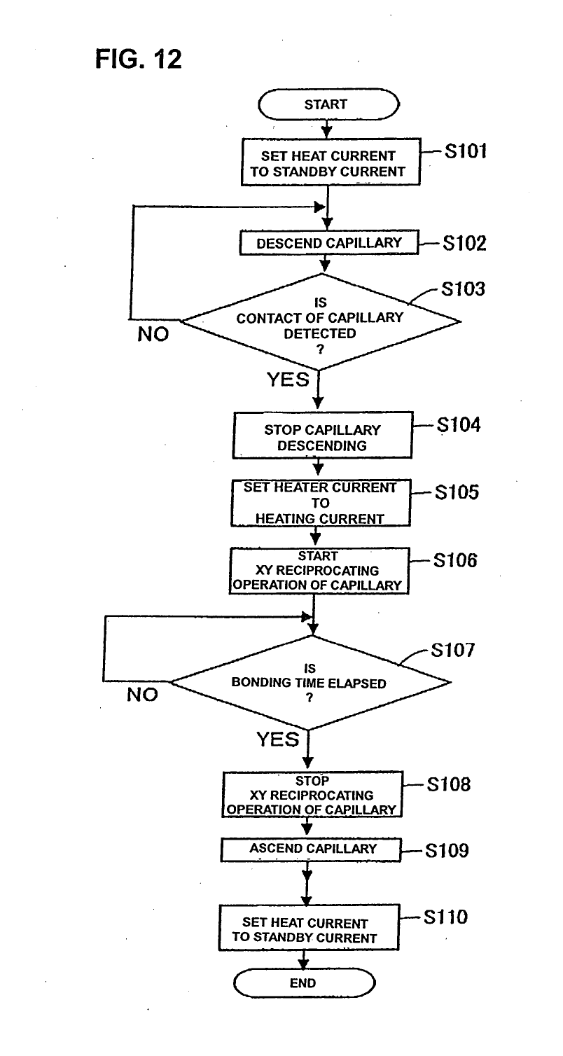

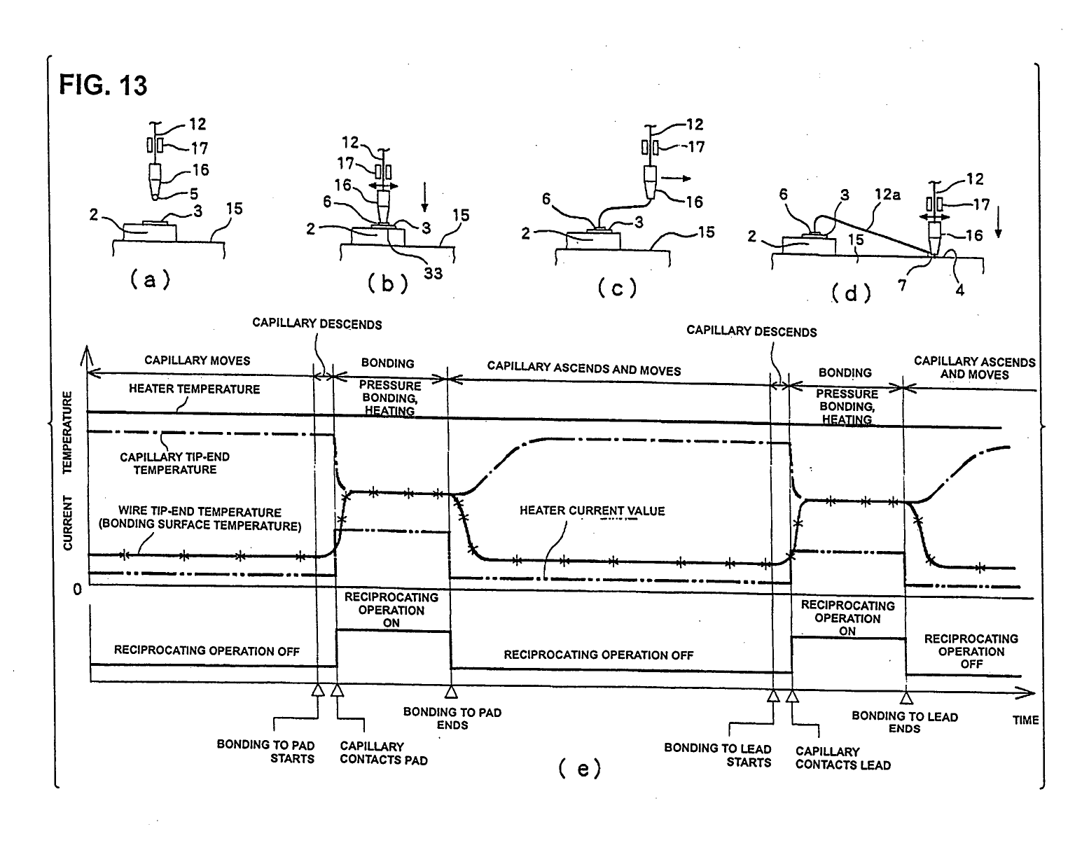

A method of performing wire bonding with the wire bonder 10 of the above-described embodiments, an embodiment of the wire bonding program, and an operation of the program will be described with reference to FIGS. 12 and 13. FIG. 12 is a flowchart of the embodiment of a wire bonding method and program, and FIG. 13 shows the operation of the embodiment. The wire bonder 10 has the system structure shown in FIG. 1.

Before the capillary 16 pressure-bonds the wire 12 to the pad 3 after the bonding step has started, in step S101 of FIG. 12, the control unit 71 outputs a command to the heater interface 81. In the command, an electric current at the heater 31 is set to a standby current. The standby current is an electric current with which the heater 31 can be kept at a predetermined temperature, e.g., at 500° C. higher than the wire bonding temperature, and the standby current is an electric current which is smaller than an electric current passed in performing the pressure bonding and heating of the wire. On the basis of the command, the heater interface 81 controls the current so as to output the standby current to the heater 31.

Chart (e) in FIG. 13 shows the heat source temperature, the temperature at the tip end of the capillary, the temperature at the tip end of the wire, and the heater current in this state of things. The temperature at the tip end of the capillary indicates temperatures of the inner chamfer portion 49 and face portion 47 at the tip end of the capillary, and the temperature at the tip end of the wire indicates the temperature of the ball 5 at the tip end of the wire 12 or the temperature of the bonding surface 53.

As shown in FIG. 5, before the capillary 16 comes into contact with the pad 3, portions of the pressure bonding surfaces of the inner chamfer portion 49 and face portion 47 are in contact with the ball 5 and wire 12, and the heat is transferred to the ball 5 and wire 12 from the contact points. However, since the ball 5 and wire 12 is not in contact with the pad, the heat radiation amount is small, and the less current for keeping the temperature is required. In this situation, since a large contact thermal resistance is generated between the ball 5 and the pressure bonding surfaces of the inner chamfer portion 49 and face portion 47 at the tip end of the capillary, as shown in chart (e) of FIG. 13, the ball 5 at the tip end of the wire has a temperature lower than the temperature at the tip end of the capillary 16. The heat is supplied from the heater 31 to the tip end of the capillary through the heat supply path formed by the diamond layer 39. However, since the thermal resistance exists in the heat supply path, the temperature at the tip end of the capillary is lower than the heater temperature. In the continuous bonding steps, when the heater current already becomes the standby current in the previous step, the same current state is retained.

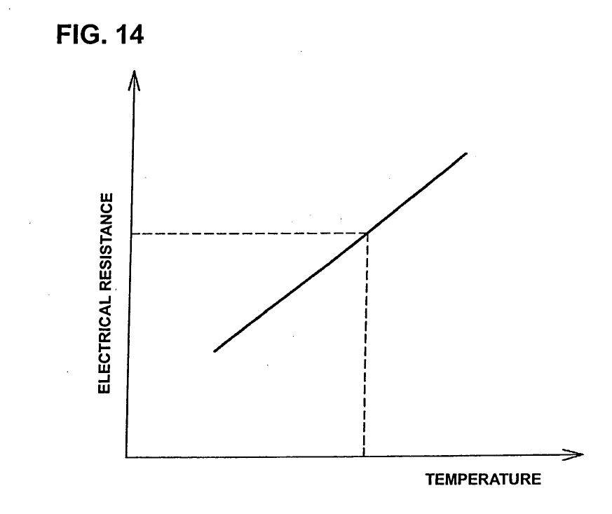

The standby current can be controlled at a constant predetermined value, or a temperature control method can be adopted by measuring the resistance of the heater 31. As shown in FIG. 14, in the heater 31 of the shown embodiment, there is a positive correlation between the resistance and the temperature, so that the resistance increases as the temperature of the heater 31 increases. Accordingly, the relationship between the temperature and the resistance is stored as data in the storage unit 75, the resistance of the heater 31 is computed from the voltage between both ends of the heater 31 and the current at the heater 31, the temperature of the heater 31 is determined from the storage data, and the current or voltage at the heater 31 can be controlled such that the heater 31 becomes a predetermined temperature. Therefore, there is an advantageous effect that the temperature can be controlled in the simple way without attaching a temperature sensor to the vicinity of the heater 31 which is small in size.

In this case, the control unit 71 obtains signals of the voltage and current applied to the heater 31 from the heater interface 81, the control unit 71 computes the resistance from the voltage signal and current signal, and the control unit 71 outputs a command of the current or voltage to the heater 31 such that the heater 31 becomes a predetermined temperature. Upon receiving the command, the heater interface 81 outputs the current signal or voltage signal to the heater 31. This enables the control unit 71 to keep the diamond layer 39 around the heater 31 at the predetermined temperature.

After the current at the heater 31 is set to the standby current, the control unit 71 outputs a command to the moving mechanism interface 79 to lower the capillary 16 in step S102 of FIG. 12. On the basis of the command, the moving mechanism interface 79 outputs a signal in order to drive the motor of the bonding head 19 to move the bonding arm 13 downward, and the moving mechanism interface 79 moves the bonding arm 13 toward the pad 3. Illustration (b) in FIG. 3 shows the state in which the capillary 16 is lowered to come into contact with the pad 3. When the capillary 16 comes into contact with the pad 3, the current flows through the wire 12. The conducting-state obtaining means 22 detects the conducting current from the wire 12 to the pad 3, and the signal of the conducting current is inputted from the conducting-state obtaining means interface 77 to the control unit 71. The conducting-state obtaining means 22 can be a direct-current type which detects the state change in the direct current between the wire 12 and the pad 3 or between the wire 12 and the lead 4, or the conducting-state obtaining means 22 can be an alternating current type which detects the change in the alternating current.

When in step S103 the contact of the capillary 16 with the pad 3 is detected by the contact signal from the conducting-state obtaining means 22, the control unit 71 outputs a command to the moving mechanism interface 79 to stop the lowering of the capillary in step S104. Upon receiving the command, the moving mechanism interface 79 outputs a signal in order to stop the motor of the bonding head 19 to stop the downward movement of the bonding arm 13. Therefore, the downward movement of the bonding arm 13 is stopped and the lowering operation of the capillary 16 is also stopped. The capillary 16 starts the pressure bonding of the wire 12 to the pad 3 by the contact of the capillary 16.

In the next step S105 of FIG. 12, when the control unit 71 detects the contact of the capillary 16, the control unit 71 outputs a command to the heater interface 81 to switch the current of the heater 31 from the standby current to a heating current which is larger than the standby current. On the basis of the command, the heater interface 81 changes the heater current from the standby current to the heating current.

As shown in illustration (b) of FIG. 13, when the capillary 16 compresses the ball 5 at the tip end to form the pressure bonding ball 6 after coming into contact with the pad 3, the inner chamfer portion 49 and face portion 47 at the tip end of the capillary 16 are pressure-bonded to the pressure bonding ball 6, and the heat flows largely from the heater 31 toward the pad 3. Therefore, as shown in chart (e) of FIG. 13, the temperature of the bonding surface at the tip end of the wire is rapidly increased. On the other hand, since the pressure bonding ball 6 at the tip end of the wire is pressure-bonded to the pad 3, the heat flowing from the heater 31 to the pressure bonding ball 6 flows toward the semiconductor chip 2 through the bonding surface 53. Therefore, the heat flow rate from the heater 31 to the inner chamfer portion 49 and face portion 47 at the tip end of the capillary is increased, which rapidly increases the temperature difference between the heater 31 and the tip end of the capillary. The inner chamfer portion 49 and the face portion 47 at the tip end of the capillary are pressure-bonded to the pressure bonding ball 6 at the tip end of the wire, so that the thermal resistance therebetween is rapidly decreased. As a result, the inner chamfer portion 49 and the face portion 47 at the tip end of the capillary have the substantially same temperature as the pressure bonding ball 6 at the tip end of the wire. As shown in chart (e) of FIG. 13, the bonding surface 53 which is the lower surface of the pressure bonding ball 6 also has the substantially same temperature as the tip end of the capillary 16. In this state of things, the bonding surface 53 is kept at the wire bonding temperature. The wire bonding temperature is a temperature at which the bonding property of the bonding portion can be improved, e.g., a temperature ranging from 200° C. to 300° C.

In the shown embodiment, the current is controlled such that the temperature around the heater 31 becomes the heating temperature in which the temperature difference between the heated heater 31 and the heated bonding surface is added to the wire bonding temperature, e.g., the heating temperature being 500° C., which allows the temperature of the bonding surface 53 to be kept and controlled. As described above, in the temperature keeping control, the relationship between the temperature and the resistance of the heater 31 is stored as data in the storage unit 75, the resistance of the heater 31 is computed from the voltage between both ends of the heater 31 and the current at the heater 31, the temperature of the heater 31 is determined from the storage data, and the current or voltage of the heater 31 can be controlled such that the heater 31 becomes a predetermined temperature.

In this case, the control unit 71 obtains the signals of the voltage and current applied to the heater 31 from the heater interface 81, the control unit 71 computes the resistance from the voltage signal and current signal, and the control unit 71 outputs the command of the current or voltage to the heater 31 such that the heater 31 becomes the predetermined temperature. Upon receiving the command, the heater interface 81 outputs the current signal or voltage signal to the heater 31. Therefore, the control unit 71 keeps the diamond layer 39 around the heater 31 at the predetermined temperature, which allows the bonding surface 53 to be kept and controlled at the wire bonding temperature.

The temperature keeping control of the bonding surface 53 is not limited to the above-described control method as long as the bonding surface 53 can be kept at the wire bonding temperature. For example, the type of the semiconductor chip 2, the heating current based on the wire diameter, and the temperature of the bonding surface 53 are previously measured by a test, data table for the necessary heating current to keep the temperature of the bonding surface 53 is stored in the storage unit 75, thus controlling the heating current or voltage based on the data table. Alternatively, a constant value control in which the heating current is determined at a constant value can be adopted.

In the next step S1106 of FIG. 12, when the contact signal of the capillary 16 is inputted, the control unit 71 outputs a reciprocating operation start command to the moving mechanism interface 79 to reciprocate the capillary 16 at a frequency ranging from 2 to 3 kHz. The reciprocating operation has a low frequency not more than 1/10 compared with the resonant and exciting frequency by the ultrasonic wave having about 40 kHz. On the basis of the command, the moving mechanism interface 79 outputs a drive signal to the XY table to reciprocate the XY table 20. The XY table 20 is reciprocated according to the drive signal. The tip end of the capillary 16 is reciprocated in the XY direction (horizontal direction) by the reciprocating operation of the XY table 20, which reciprocates the bonding surface 53 with respect to pad 3. The bonding property between the bonding surface 53 of the pressure bonding ball 6 and the pad 3 is improved by the reciprocating operation.

In the shown embodiment, the tip end of the capillary 16 is reciprocated with respect to the pad 3 by the reciprocating operation of the XY table 20. The reciprocating operation is not limited to the reciprocating operation of the XY table as long as the tip end of the capillary 16 is reciprocated in the horizontal plane by forced operations.

The reciprocating operation does not need to be performed in the case that the improvement of the bonding property between the bonding surface 53 of the pressure bonding ball 6 and the pad 3 by the reciprocating operation while the bonding surface 53 is kept at the sufficiently high temperature is not required.

In the next step S107 of FIG. 12, the control unit 71 determines whether or not the pressure bonding and heating are performed for a predetermined time interval using a timer or clock operation in CPU. When the control unit 71 determines that the predetermined pressure bonding and heating elapse, the control unit 71 stops the reciprocating operation of the capillary in step S108. In the next step S109, the capillary 16 is elevated. When the capillary 16 is elevated, the inner chamfer portion 49 and face portion 47 at the tip end of the capillary 16 are separated from the pressure bonding ball 6 at the tip end of the wire, which ends the pressure bonding of the wire 12 to the pad 3 by the capillary 16. Since the heat transfer amount to the tip end of the wire derived from the tip end of the capillary is decreased, the wire temperature (temperature of derived wire) at the tip end of the capillary is lowered. The control unit 71 next outputs the command to the heater interface 81 to set the current at the heater 31 to the standby current in step S110. The heater interface 81 switches the current at the heater 31 to the standby current based on the command.

As shown in chart (e) of FIG. 13, the heater 31 is kept at the predetermined temperature by the standby current. On the other hand, in the capillary 16, the temperature of the tip end portion is gradually raised by the standby current, and the tip end portion reaches the temperature of before the start of the bonding. The capillary 16 in this state is moved onto the lead 4, which is another bonding object in the present invention. When the capillary 16 is moved onto the lead 4, bonding to the lead 4 is performed by repeating the same bonding step as described above. In the bonding to the lead 4, the inner chamfer portion 49 and face portion 47 at the tip end of the capillary directly pressure-bond the wire 12a to the lead 4 to form a bonding portion 7, thus connecting the wire 12 to the lead 4. In the bonding between the wire 12 and lead 4, the bonding (or contact) surface 53 which is formed by (or lies between) the wire 12 and the pad 4 is heated to high temperature. When the bonging to the lead 4 is ended, the current at the heater 31 is set back to the standby current. The standby current keeps the heater 31 at the predetermined temperature. Then, the capillary 16 is moved to the next pad 3 to continue the bonding.

According to the bonding method and program of the embodiment, the heater 31 is heated to the high temperature, which allows the bonding surface 53 to be heated to the higher temperature compared with the bonding surface temperature in the conventional bonding. Therefore, there is the advantageous effect of being able to perform the bonding without performing high-frequency vibration by the ultrasonic horn during the pressure bonding. The large current for heating flows when the capillary 16 pressure-bonds the wire 12 to the pad 3, and the standby current which is of the small current is set when the capillary 16 does not pressure-bond the wire 12 to the pad 3. Therefore, there is an advantageous effect that the bonding arm 13 can be heated by heating the capillary 16 to decrease the generation of the positional error of the bonding. Since the bonding can be performed by locally heating the wire bonding portion, there is an advantageous effect that the less electric power is required for heating when compared with the bonding method in which the entire semiconductor chip 2 is heated. In the present invention, the resistance of the heater 31 is computed, the temperature of the heater 31 is determined from the storage data, and the current or voltage at the heater 31 is controlled such that the heater 31 becomes the predetermined temperature. Therefore, there is an advantageous effect that the temperature can be controlled in the simple way without attaching a temperature sensor to the vicinity of the heater 31 which is small in size.

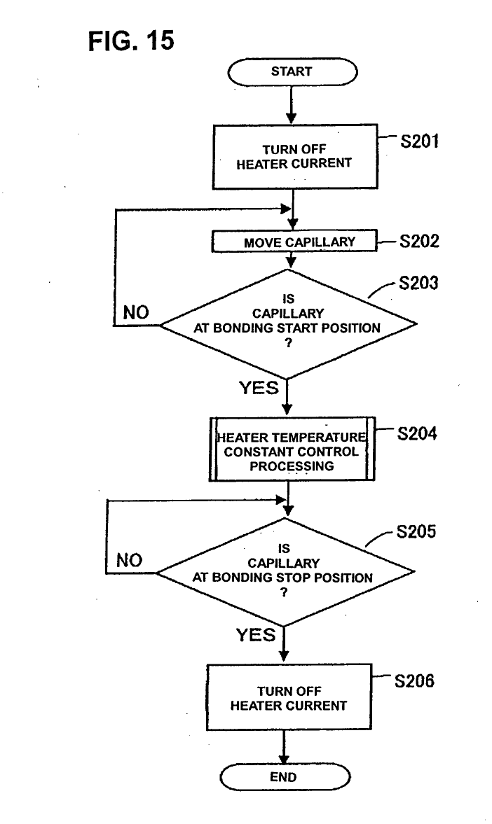

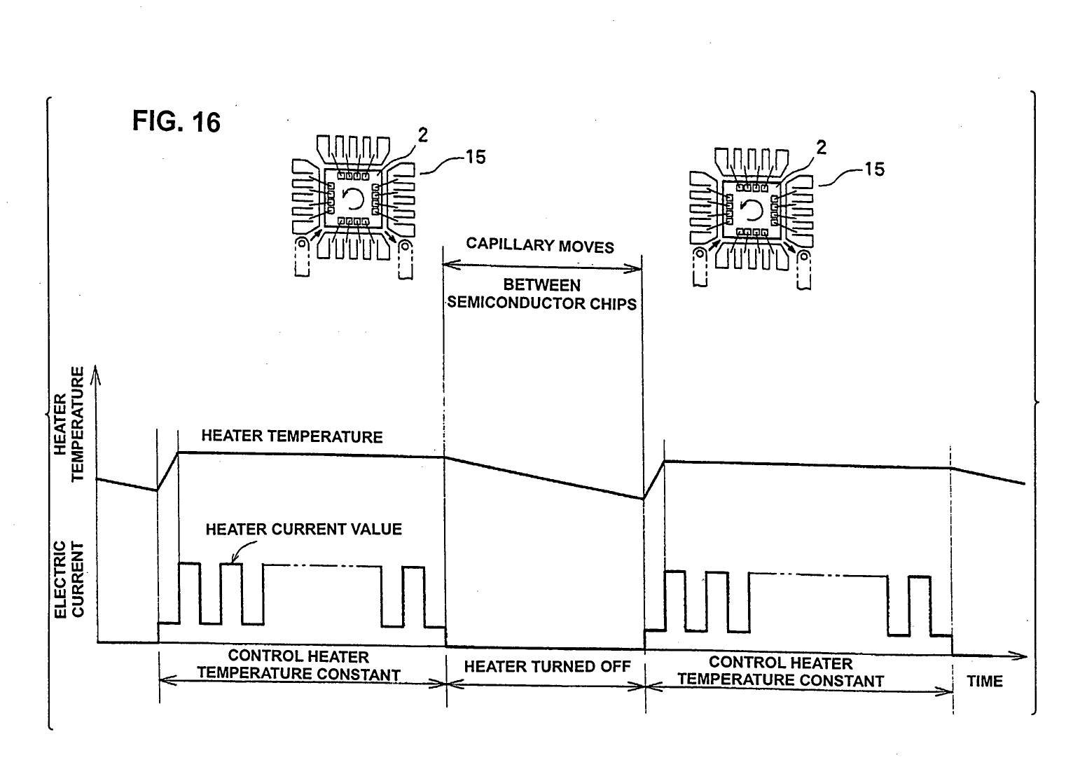

Another embodiment of the wire bonding method, program and operation thereof according to the present invention will be described below with reference to FIGS. 15 and 16. FIG. 15 is a flowchart showing another embodiment of the wire bonding method and program, and FIG. 16 shows the operation of another embodiment. The wire bonder 10 includes the system structure shown in FIG. 1. The same portion as the above-described embodiment of the wire bonding method and program is designated by the same numeral, and the description is omitted.

In this embodiment, during the continuous bonding of many semiconductor chips 2 and lead frames 15, the current at the heater 31 is set to zero when the capillary 16 is being moved from a bonding between the semiconductor chip 2 and lead frame 15 to a next bonding between other semiconductor chip 2 and lead frame 15. The control unit 71 outputs a command to the heater interface 81 to set the current at the heater 31 to zero or to turn off the power supply in step S201 of FIG. 15. The heater interface 81 sets the current at the heater 31 to zero based on the command. During the continuous bonding steps, when the heater current is already set to zero in the previous step, the state is maintained without changes.

As shown in FIG. 16, after the bonding step to the previous semiconductor chip 2, the heater 31 is kept at the predetermined temperature like the case in which the bonding to the lead 4 is ended as shown in chart (e) of FIG. 13, and the tip end of the capillary has the temperature slightly lower than the heater temperature. When the current at the heater 31 becomes zero in this state, the temperature of the heater 31 is gradually decreased.

When the command that the capillary 16 is moved to the bonding start position is issued by the normal bonding program in steps S202 and S203 of FIG. 15, the control unit 71 turns on the heater 31 to perform temperature control processing of the heater 31 in the next step S204. The temperature control processing of the heater 31 is executed in the same manner as described with reference to FIGS. 12 and 13. Therefore, the control is performed such that the current at the heater 31 is set to the heating current for keeping the temperature of the bonding surface formed by the wire 12 and the pad 3 at the wire bonding temperature or more in the case where the capillary 16 pressure-bonds the wire 12, and the control is performed such that the current is set to the standby current for keeping the heater 31 at the predetermined temperature in the case where the capillary 16 does not pressure-bond the wire 12. In the shown embodiment, the heater 31 is kept at the predetermined constant values in either one of the heating and standby currents.

When the bonding with the predetermined bonding program is ended, the control unit 71 outputs the command for moving the capillary 16 to the bonding start position of the next semiconductor chip 2 in step S205 of FIG. 15, and the control unit 71 sets the current at the heater 31 to zero in the next step S206.

As shown in FIG. 16, when the current at the heater 31 is set to zero, the temperature of the heater 31 is gradually lowered according to the movement of the capillary. When the command that the capillary 16 is moved to the bonding start position of the next semiconductor chip 2 is issued again by the normal bonding program, similarly the control unit 71 performs the temperature control processing of the heater 31.

In addition to the advantageous effects of the above-described embodiment, the bonding method and program of the embodiment shown in FIGS. 15 and 16 has the advantageous effect of further reducing the electric power consumed during the heating, because the heating power supply is turned off when the capillary 16 is moved between the semiconductor chips 2. There is a further advantageous effect that the bonding arm 13 is heated by heating the capillary 16 to be able to further decrease the generation of the positional error of bonding.

The bonding method and the bonding program of the invention are described for the wire bonder 10 provided with the capillary 16. Similarly, the bonding method and the bonding program of the present invention can be applied to a wire bonder provided with the wedge tool 55.

1. A wire bonder provided with a wire bonding tool for bonding a wire to bonding objects, the wire bonder comprising:
a wire heating portion for heating said wire, said wire heating portion being formed at a tip end portion of said wire bonding tool;
a heat source for generating heat to heat said wire, said heat source being formed on an outer surface side of said wire bonding tool; and
a heat supply path for supplying heat for heating said wire from said heat source to said wire heating portion.

2. The wire bonder according to claim 1, wherein the wire bonder further comprises a computer for controlling pressure-bonding of said wire to said bonding objects, and said computer includes a temperature keeping means for keeping a temperature of a bonding surface formed by said wire and said bonding objects at a wire bonding temperature higher than a temperature of a circuit component portion of said semiconductor chip when said wire is pressure-bonded to said bonding objects by said wire bonding tool.

3. The wire bonder according to claim 2, wherein the wire bonder further comprises a moving mechanism for moving said wire bonding tool in XYZ directions to bond said wire to said bonding objects, and said computer further includes a vibration means for vibrating the tip end portion of said wire bonding tool relative to said semiconductor chip using said moving mechanism when said wire is pressure-bonded to said bonding objects by said wire bonding tool.

4. The wire bonder according to claim 1, wherein said heat supply path is made of a material having a thermal conductivity larger than that of said semiconductor chip.

5. The wire bonder according to claim 4, wherein said heat supply path is made of one of a diamond crystal and a nano-carbon material.

6. The wire boner according to claim 2, wherein said computer further comprises a heat source temperature adjusting means for keeping said heat source at a predetermined temperature when said wire is not pressure-bonded to said bonding objects by said wire bonding tool.

7. The wire bonder according to claim 2, wherein said computer further comprises a heat generation stop means for stopping heat generation in said heat source when said wire bonding tool is being moved from one semiconductor chip to a next semiconductor chip.

8. The wire bonder according to claim 2, wherein said temperature keeping means keeps a temperature of a bonding surface formed by said wire and said bonding objects at a wire bonding temperature higher than a temperature of a circuit component portion of said semiconductor chip based on an electrical resistance value of said heat source.

9. The wire bonder according to claim 1, wherein said bonding objects comprise a pad on a semiconductor chip and a lead on a lead frame.

10. A wire bonding method for a wire bonder, comprising the steps of:
providing said wire bonder including
a wire bonding tool for bonding a wire to bonding objects,
a wire heating portion for heating said wire, said wire heating portion being formed at a tip end portion of said wire bonding tool,
a heat source for generating heat to heat said wire, said heat source being formed on an outer surface side of said wire bonding tool,
a heat supply path for supplying heat for heating said wire from said heat source to said wire heating portion, and
a computer for controlling pressure-bonding of said wire to said bonding objects; and
keeping a temperature of a bonding surface formed by said wire and said bonding objects at a wire bonding temperature higher than a temperature of a circuit component portion of said semiconductor chip when said wire is pressure-bonded to said bonding objects by said wire bonding tool.

11. The wire bonding method for a wire bonder according to claim 10, further comprising the steps of:
providing a moving mechanism for moving said wire bonding tool in XYZ directions to bond said wire to said bonding objects; and
vibrating the tip end portion of said wire bonding tool relative to said semiconductor chip using said moving mechanism when said wire is pressure-bonded to said bonding objects by said wire bonding tool.

12. The wire bonding method for a wire bonder according to claim 10, further comprising a step of adjusting a heat source temperature to keep said heat source temperature at a predetermined temperature when said wire is not pressure-bonded to said bonding objects by said wire bonding tool.

13. The wire bonding method for a wire bonder according to claim 10, further comprising a step of stopping a heat generation in said heat source when said wire bonding tool is being moved from one semiconductor chip to a next semiconductor chip.

14. The wire bonding method for a wire bonder according to claim 11, further comprising a step of stopping a heat generation in said heat source when said wire bonding tool is being moved from one semiconductor chip to a next semiconductor chip.

15. The wire bonding method for a wire bonder according to claim 10, wherein said temperature keeping step keeps a temperature of a bonding surface formed by said wire and said bonding objects at a wire bonding temperature higher than a temperature of a circuit component portion of said semiconductor chip based on an electrical resistance value of said heat source.

16. The wire bonding method for a wire bonder according to claim 10, wherein said bonding objects comprise a pad on a semiconductor chip and a lead on a lead frame.
